(19) United States
(12) Patent Application Publication
(10) Pub. No.: US 2018/0183691 A1
(43) Pub. Date: Jun. 28, 2018

(54) ASSEMBLY FOR IDENTIFYING, SHARING AND MANAGING DATA INCLUDING CRITICAL DATA AND NON-CRITICAL DATA

(71) Applicant: THALES, COURBEVOIE (FR)

(72) Inventors: Laurent LALUQUE, MERIGNAC (FR); Bruno CAPELLE, MERIGNAC (FR); Sébastien ELLERO, MERIGNAC (FR); Xavier SERVANTIE, MERIGNAC (FR)

(21) Appl. No.: 15/843,964

(22) Filed: Dec. 15, 2017

(30) Foreign Application Priority Data
Dec. 22, 2016 (FR) 1601836

(51) Int. Cl. H04L 12/26; H04L 29/08

(52) U.S. Cl. CPC H04L 43/04; H04L 67/12

(57) ABSTRACT

A computer assembly for identifying and managing data comprises a server including software providing a determined function transforming input data into output data. The computer system comprises: a first system and a second system, the first system being a critical system; a first digital interface for monitoring the identifier of the data and bidirectionally transmitting data between the server and the critical system; a first physical interface for physically linking the first digital interface with the critical system; a second digital interface for monitoring and bidirectionally transmitting data between the server and the second system; a second physical interface for physically linking the second digital interface with the second system.

### CROSS-REFERENCE TO RELATED APPLICATIONS

This application claims priority to foreign French patent application No. FR 1601836, filed on Dec. 22, 2016, the disclosure of which is incorporated by reference in its entirety.

### FIELD OF THE INVENTION

The field of the invention is that of complex computer assemblies or systems that must manage critical data and non-critical data. The invention is most particularly applicable to the field of avionics.

### BACKGROUND

The term “critical computer datum” is understood to mean a datum arising from a system, the failure or malfunction of which could have severe consequences for human life or could lead to substantial material damages or have harmful effects on the environment. The on-board avionics system of an aircraft is typically considered to be a critical system, the consequences of such a system malfunctioning potentially being catastrophic.

Conversely, non-critical data cannot not lead to severe consequences. The data provided by mass-market computing means are considered to be such. By way of example, laptop computers and tablet computers come under this category. GSM (Global System for Mobile Communication) communication networks are considered to be non-critical systems.

The security of a critical system is an essential element of the system. One of the means for securing a critical system is to limit its possibilities of dialogue with other systems and in particular with non-critical systems. Thus, critical systems are often called “closed-world” systems, whereas non-critical systems are called “open-world” systems.

This absence of dialogue between “closed-world” and “open-world” systems restricts the possibilities of using the critical system according to its initial specifications. As mass-market computing continues to develop, this restriction becomes increasingly sensitive in that it limits the capabilities of the critical system.

A dialogue between “open-world” and “closed-world” systems that observed the security requirements of the closed world system would allow new functions to be carried out on the basis of data from the open-world system. For performing this dialogue, a number of solutions have been proposed. Thus, the patent U.S. Pat. No. 9,141,830 entitled “Avionics gateway interface, systems and methods” describes a solution for connecting an avionics system and a tablet by means of a computer gateway. Information generated by an uncertified device may thus be incorporated into a certified avionics system after verification by the pilot. This method is constructed so that the datum crossing between the open-world system and the avionics system is the same. The patent FR 2936068 entitled “Procédé et dispositif d'encapsulation d'applications dans un système informatique pour aéronef” (“Method and device for encapsulating applications in an aircraft computer system”) describes a mechanism for sharing a computer system in order to run two applications simultaneously without them interfering with one another, but the two applications cannot collaborate.

### SUMMARY OF THE INVENTION

The computer assembly according to the invention does not have these drawbacks. It provides the possibility of using data arising from the open world to build, for example, new functions while monitoring them so as to keep the initial level of security of the closed world. More specifically, the subject of the invention is a computer assembly for identifying, sharing and managing data, said computer system comprising at least one data server, said server including software providing a determined function, said determined function transforming or translating input data into output data, characterized in that said computer assembly includes at least:
a first and a second system, the first system being a critical system;
a first digital interface for monitoring and bidirectionally transmitting data between the data server and the critical system, the monitoring of each datum consisting in verifying that the datum is in accordance with a predetermined definition, belongs to a predetermined list, includes a unique identifier and has the source of its application in its identifier;
a first physical interface for physically linking the first digital interface with the critical system;
a second digital interface for monitoring and bidirectionally transmitting data between the data server and the non-critical system, the monitoring of each datum consisting in verifying that the datum is in accordance with a predetermined definition, belongs to a predetermined list, includes a unique identifier and has the source of its application in its identifier;
a second physical interface for physically linking the second digital interface with the second system.

Advantageously, the second system is a critical or non-critical system.

Advantageously, the non-critical system is a tablet computer and the second digital interface is a WEB Service/REST interface or an NMEA (National Marine Electronics Association) interface and the second physical interface is a wireless or Wi-Fi interface.

Advantageously, the non-critical system is an ISP (Internet service provider) computer server and the second physical interface is a GSM (Global System for Mobile Communications) interface.

Advantageously, the first physical interface for physically linking the first digital interface and the critical system is an Ethernet interface.

Advantageously, the identifier of the data is a URI (Uniform Resource Identifier).

Advantageously, the critical system is an avionics system including at least one viewing system and a human-machine interface.

Advantageously, the datum arising from the non-critical system is a geolocated datum or a geolocated terrain area.

Advantageously, the determined function is an information presentation function or a hardware activation function.

### BRIEF DESCRIPTION OF THE DRAWING

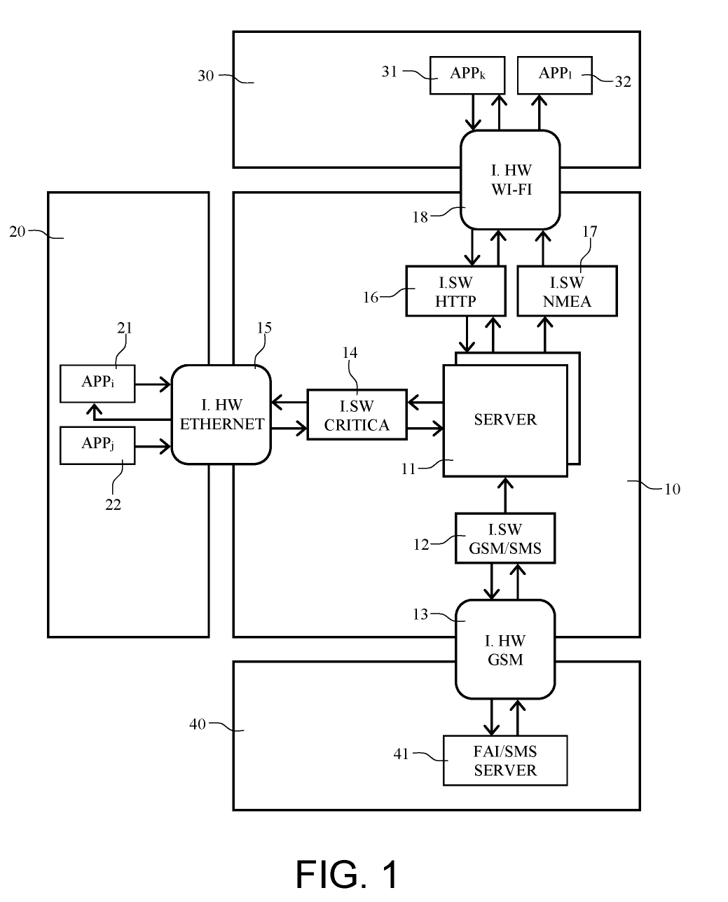

The invention will be better understood and other advantages will become apparent upon reading the following non-limiting description and by virtue of the appended FIG. 1, which shows the overview of a computer assembly for identifying, sharing and managing data according to the invention.

### DETAILED DESCRIPTION

The computer assembly according to the invention uses at least two systems linked by a computer server. One of the two systems is necessarily a critical system. The second system may also be a critical system. However, the invention is most particularly applicable when the second system is a non-critical system belonging to the open world.

By way of non-limiting example, the computer assembly according to the invention is shown in FIG. 1 for the case of a first, critical system and two second, non-critical systems.

The configuration shown includes a computer device 10 primarily comprising a central computer server 11 communicating with a critical system 20 and two non-critical systems 30 and 40. Of course, the invention is not limited to this sole configuration. The system may include multiple servers placing a plurality of critical systems in communication with a plurality of non-critical systems. The computer device 10 may be a standalone electronic computer or a set of electronic circuit boards forming part of a larger system.

The core of the system is the computer server 11, which includes application software and data. Depending on the input data provided by various interfaces, it transforms or translates these input data into output data and delivers these output data over the same interfaces or over other interfaces that will be used by applications denoted by “APPₓ” in FIG. 1.

Each interface between the server and the outside world includes two sub-assemblies, namely a digital interface and a physical interface. The digital interface monitors and bidirectionally transmits data between the data server and the critical system. Read or read/write access to a datum is defined by this digital interface. The monitoring of each datum consists in verifying that the datum is in accordance with a predetermined definition, belongs to a predetermined list, includes a unique identifier and has the source of its application in its identifier.

The physical interface physically links the first digital interface with the critical system.

The fact that the data include a unique identifier prevents an open-world data producer from modifying the closed-world data and vice versa. The identifier of the data may be a URI (Uniform Resource Identifier).

In FIG. 1, the server is connected to a critical system 20 and two non-critical systems 30 and 40 by means of the interfaces 12 to 18 described below.

By way of first example, the critical system 20 is an avionics system used for aircraft flight and navigation. Generally, it includes at least one viewing system and one dedicated human-machine interface. The viewing system includes multiple viewing devices, which may be of different natures. These may be instrument panel viewing devices or “head-up” viewing devices.

In this case, the server is linked to the avionics system through the “I. SW” critical digital interface 14 and the “I. HW” physical interface 15. The latter interface 15 may be an Ethernet interface. In this context, the identifiers of the data may be “/avionics/xxx”-type identifiers for data intended for the avionics system and “/openworld/xxx”-type identifiers for the data intended for the open world of the non-critical systems. For example, the identifier “/avionics/pitch” provides information on the pitch of the aircraft and the identifier “/openworld/poi/latitude” provides the latitude of a point of interest. This interface 15 is linked to the “APPᵢ” application 21 and to the “APPⱼ” application 22.

By way of second example, the non-critical system 30 is a “mass-market” tablet computer. In this case, the “I. SW” digital interface 16 may be a REST web services interface. REST (representational state transfer) web services are based on the architecture of the web and its basic standards are the HTTP (Hypertext Transfer Protocol) protocol and URI identifiers.

The “I. SW” digital interface 17 may be an NMEA (National Marine Electronics Association) interface. The second “I. HW” physical interface 18 is a wireless, Wi-Fi or Bluetooth interface. In FIG. 1, it is linked to the “APPₖ” application 31 and to the “APPₗ” application 32.

By way of third example, the non-critical system 40 includes an ISP (Internet service provider) computer server 41 belonging to telecom infrastructure and the physical interface 13 may be a GSM (Global System for Mobile Communications) interface. With the latter application, it becomes possible to broadcast and to take into account information arising from an SMS (Short Message Service) throughout the avionics system.

A first advantage of the computer assembly for identifying, sharing and managing data according to the invention is to be able to provide a critical system with web data and vice versa.

The second advantage of this type of assembly is that it allows new functions to be implemented that would not have been possible otherwise. These new functions are primarily information presentation functions or hardware activation functions.

By way of first exemplary application, in the case of an avionics system for a helicopter including a device for detecting the position of the head of the pilot, if the “open” world provides the direction of the spotlight of the helicopter, then it is possible to create a new application in which the spotlight is controlled by the head of the pilot.

By way of second example, if the avionics system includes a device for detecting the position of the head of the pilot coupled with a helmet-mounted viewing device, and if the open world provides a georeferenced point of interest, this point of interest may appear in the helmet-mounted viewing device.

By way of third example, if the avionics system transmits a datum representing the geographical position of the aircraft, this position may be transmitted to a graphics tablet and the position of the aircraft may then appear in an online mapping system.

1. A computer assembly for identifying, sharing and managing data, said computer system comprising at least one data server, said server including software providing a determined function, said determined function transforming or translating input data into output data, wherein said computer system includes at least:
a first system and a second system, the first system being a critical system;
a first digital interface for monitoring and bidirectionally transmitting data between the data server and the critical system, the monitoring of each datum comprising verifying that the datum is in accordance with a predetermined definition, belongs to a predetermined list, includes a unique identifier and has the source of its application in its identifier;
a first physical interface for physically linking the first digital interface with the critical system;
a second digital interface for monitoring and bidirectionally transmitting data between the data server and the second system, the monitoring of each datum comprising verifying that the datum is in accordance with a predetermined definition, belongs to a predetermined list, includes a unique identifier and has the source of its application in its identifier;
a second physical interface for physically linking the second digital interface with the second system.

2. The computer assembly according to claim 1, wherein the second system is a critical system.

3. The computer assembly according to claim 1, wherein the second system is a non-critical system.

4. The computer assembly according to claim 3, wherein the non-critical system is a tablet computer and wherein the second digital interface is a WEB Service/REST interface or an NMEA (National Marine Electronics Association) interface and wherein the second physical interface is a wireless or Wi-Fi interface.

5. The computer assembly according to claim 3, wherein the non-critical system is an ISP (Internet service provider) computer server and wherein the second physical interface is a GSM (Global System for Mobile Communications) interface.

6. The computer assembly according to claim 1, wherein the first physical interface for physically linking the first digital interface and the critical system is an Ethernet interface.

7. The computer assembly according to claim 1, wherein the identifier of the data is a URI (Uniform Resource Identifier).

8. The computer assembly according to claim 1, wherein the critical system is an avionics system including at least one viewing system and a human-machine interface.

9. The computer assembly according to claim 3, wherein the datum arising from a non-critical system is a geolocated datum or a geolocated terrain area.

10. The computer assembly according to claim 1, wherein the determined function is an information presentation function or a hardware activation function.
